(19) United States
(12) Patent Application Publication
(10) Pub. No.: US 2016/0348573 A1
(43) Pub. Date: Dec. 1, 2016

(54) COMBUSTION ENGINE AIR INTAKE SYSTEM

(71) Applicant: VALEO SYSTEMES DE CONTROLE MOTEUR, Cergy Saint Christophe (FR)

(72) Inventors: Julien Marcinkowski, Sartrouville (FR); Piotr Zakrzewski, Acheres (FR); Florent David, Suresnes (FR)

(73) Assignee: Valeo Systemes de Controle Moteur, Cergy Saint Christophe (FR)

(21) Appl. No.: 15/106,473

(22) PCT Filed: Dec. 11, 2014
(86) PCT No.: PCT/FR2014/053273

§ 371 Date: Aug. 23, 2016

(30) Foreign Application Priority Data
Dec. 19, 2013 (FR) 1363081

(51) Int. Cl. F02B 33/44; F02M 35/108; F02M 35/10; F02B 39/10

(52) U.S. Cl. CPC F02B 33/446; F02B 39/10; F02M 35/108; F02M 35/10059; F02M 35/10354

(57) ABSTRACT

The present invention relates to an assembly (1) for a combustion engine (10) comprising an electric compressor (5) and an air intake system, the air intake system comprising a double manifold (2) at the inlet to which there is a valve (4) configured to allow the intake gases to circulate in the manifold (2) and/or to allow the intake gases to bypass the electric compressor (5). The double manifold (2) comprises a swirl manifold (22) and a filling manifold (21), fed by two independent inlets, which can be closed off by the valve (4) independently of one another.

This invention relates to the field of combustion engine air intake systems, and more particularly to an assembly for a combustion engine of a motor vehicle comprising an air intake system and an electric compressor configured to improve the internal aerodynamics of the engine.

The combustion engines covered by this invention are petrol, diesel, gas, ethanol engines, whether supercharged or not.

The internal aerodynamics of piston engines greatly influence the quality of combustion and therefore fuel consumption and polluting emissions. Controlling and changing these aerodynamics on the basis of operating conditions is therefore a major challenge for observing the ever stricter emissions and consumption standards.

Among the known means of changing the internal aerodynamics of an engine, we can cite intake systems comprising in certain cases a shut-off butterfly type valve and swirl and/or tumble flaps, which involve closing off all or part of a pipe. In certain diesel engines with two inlet valves per cylinder, one valve is fed by a filler pipe and the other by a swirl pipe. By more or less closing off the filler pipe, for example by a flap, the rate of swirl can be changed. Conventionally, the intake manifold has one inlet and as many outlets as there are cylinders, the separation between the filler and swirl pipes occurring in the cylinder head for each cylinder. Consequently, as many swirl flaps are required as there are cylinders. So as to use only one swirl flap, it is also possible to use a double intake manifold. This originates in a Y-shaped pipe which opens into two independent manifolds, one feeding all of the swirl valves and the other all of the filler valves.

As future standards for the approval of vehicles in respect of consumption and polluting emissions have been created for much more dynamic driving with much higher loads, there is an increasing need not only to change the aerodynamics very quickly but also over a wide area of engine operation.

The drawback of the known means is that they do not allow the aerodynamics to be changed sufficiently quickly for high loads whose dynamics are very often limited by the response time of the turbocharger, and/or that they degrade consumption by introducing additional load losses.

The aim of this invention is therefore to overcome the drawbacks of the systems of the prior art by proposing an assembly for a combustion engine comprising an air intake system allowing the internal aerodynamics of a combustion engine to be changed very quickly without degrading consumption.

For this, the present invention proposes an assembly for a combustion engine comprising an electric compressor and an air intake system, the air intake system comprising a double manifold at the inlet to which there is a valve configured to allow the intake gases to circulate in the manifold and/or to allow the intake gases to bypass the electric compressor.

According to an embodiment of the invention, the double manifold comprises a swirl manifold and a filler manifold, fed by two independent inlets, which can be closed off by the valve independently of one another.

According to an embodiment of the invention, the assembly for a combustion engine according to the invention comprises a pipe bypassing the electric compressor, which can be closed off by the valve when the electric compressor is activated.

According to an embodiment of the invention, the engine's main air intake pipe divides into a first pipe and a bypass pipe that are independent and open out into the valve.

According to an embodiment of the invention, the electric compressor is arranged on the first pipe upstream of the valve.

According to an embodiment of the invention, the first pipe is arranged so that, at a given valve position, it can be the only pipe in communication with the filler and swirl pipes of the manifolds.

This invention also relates to a method of using an assembly according to the invention, comprising the following steps:
non-activation of the electric compressor,
bypassing the electric compressor by circulating the gases in the bypass pipe,
feeding the swirl pipe.

This invention also concerns a method of using an assembly according to the invention, comprising the following steps:
non-activation of the electric compressor,
bypassing the electric compressor by circulating the gases in the bypass pipe,
feeding the swirl pipe and manifold pipe.

This invention also concerns a method of using an assembly according to the invention, comprising the following steps:
activation of the electric compressor,
circulating the gases in the first intake pipe, via the electric compressor,
feeding the swirl pipe and manifold pipe.

This invention also concerns a method of using an assembly according to the invention in order to prevent any circulation of fluid in a double manifold.

Further aims, features and advantages of the invention will be better understood and emerge more clearly from the following description, referring to the accompanying Figures, given by way of example, in which:

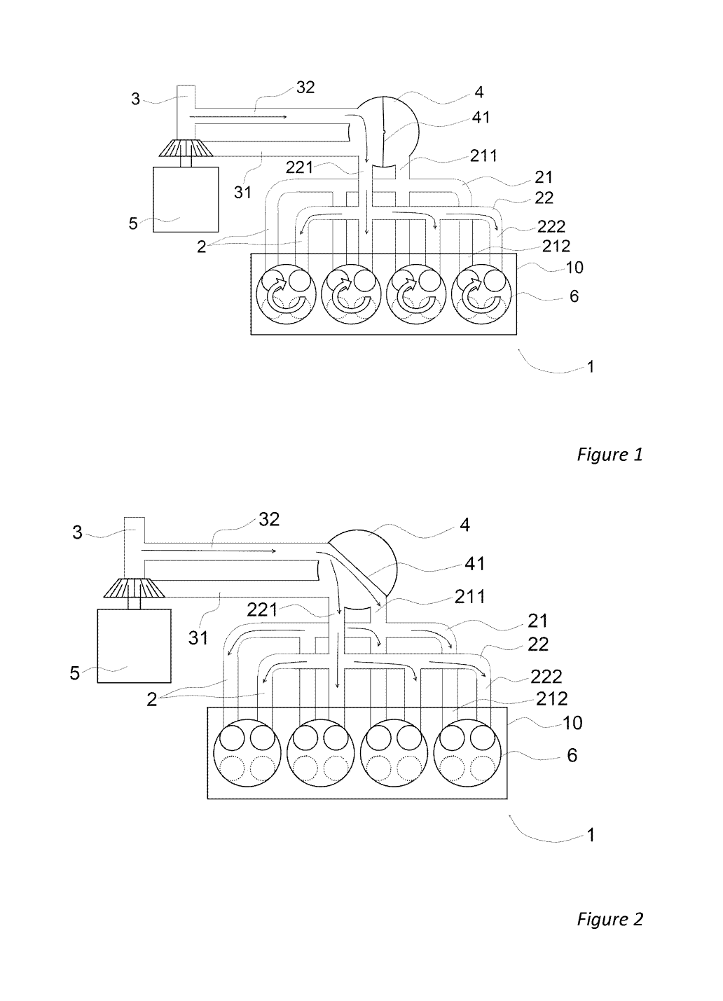

FIG. 1 is a partial schematic representation of an engine's architecture, including an electric compressor and an air intake system according to the invention, according to a first operating configuration;

FIG. 2 is a partial schematic representation of an engine's architecture, including an electric compressor and an air intake system according to the invention, according to a second operating configuration;

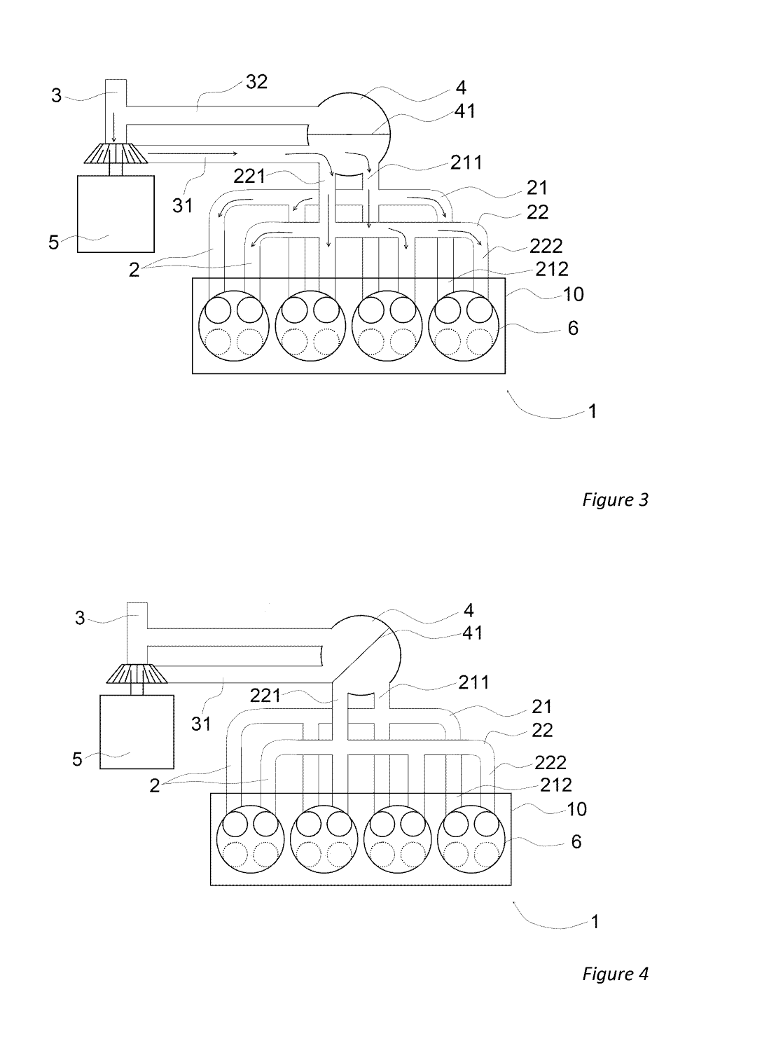

FIG. 3 is a partial schematic representation of an engine's architecture, including an electric compressor and an air intake system according to the invention, according to a third operating configuration;

FIG. 4 is a partial schematic representation of an engine's architecture, including an electric compressor and an air intake system according to the invention, according to a fourth operating configuration.

This invention relates to an assembly comprising an air intake system and an electric compressor for a combustion engine.

This invention relates to an assembly of petrol, diesel, gas, ethanol combustion engines, whether they are supercharged or not.

In the following description, an electric compressor means an air compressor, whether positive-displacement or not and for example centrifugal or radial, driven by an electric motor, with the aim of supercharging a combustion engine. The electric compressor is therefore usually activated to increase the density of the intake air. Within the scope of the invention, the electric compressor is associated with a bypass circuit enabling it to be bypassed if necessary, as described below.

The intake system used within the scope of the invention comprises a double intake manifold with two independent inlets.

The invention involves using a valve, at the manifold's inlet, which performs the functions of a shut-off butterfly valve, an aerodynamic flap and a bypass of the electric compressor, this valve being associated with an electric compressor.

Such a valve according to the invention limits the size of the engine and the associated costs. With this valve it is also possible to choose whether to use one or two manifolds of the double manifold, or not to use the manifold at all, depending on the engine conditions and loads, with an optional use of the electric compressor.

An example of engine architecture involving an assembly according to the invention is shown in FIGS. 1 to 4. The arrows in the Figures show the circulation of the intake air, also called intake gas.

The assembly 1 comprises a double intake manifold 2 comprising a filler manifold 21 and a swirl manifold 22. This double manifold 2 is arranged on the air intake pipe 3 of the engine 10. The double manifold 2 comprises two independent inlet pipes 211, 221 where a valve 4 is arranged, forming part of the assembly according to the invention. A first filler pipe 211 opens out into the filler manifold 21 and a second swirl pipe 221 opens out into the swirl manifold 22. A filler pipe therefore means the pipe that feeds the filler manifold and a swirl pipe is the pipe that feeds the swirl manifold. The swirl pipe 221 and the filler pipe 211 can be totally or partially closed off independently of one another.

According to an embodiment of the invention, each of the manifolds comprises four sub-pipes 212, 222 feeding four cylinders 6.

The assembly according to the invention also comprises an electric compressor 5 arranged upstream of the valve 4, in relation to the double manifold 2, on the engine's main air intake pipe 3.

The engine's main air intake pipe 3 separates into a first pipe 31 and a second pipe called a bypass pipe 32, both independent, the two pipes opening out in the valve 4.

The electric compressor 5 is arranged on one of these pipes, more precisely, it is arranged on the first pipe 31.

The first pipe 31 opens into the body of the valve 4 near the two manifold pipes.

More precisely, according to an embodiment of the invention, this first pipe 31 is arranged so that at a given position of the valve 4, it can be the only pipe in communication with the filler pipe 211 and swirl pipe 221 of the manifolds.

The bypass pipe 32 serves, as its name indicates, as a pipe to bypass the electric compressor 5 when the latter is not used.

The valve 4 used within the scope of the invention comprises a closing-off means 41 enabling neither, one or both pipes 31, 32 of the main intake pipe 3 to be closed off.

According to an embodiment of the invention, the closing-off means is a flap fixed to the valve at its center and capable of swiveling axially.

According to an embodiment of the invention, the valve 4 is configured so as to enable several operating modes of the system according to the invention:
Putting the two pipes 31, 32 of the main intake pipe 3 in communication with the swirl pipe 221. The electric compressor is then bypassed and the entire airflow penetrates into the cylinder through the swirl pipe 221. This configuration is shown in FIG. 1.
Putting the two pipes 31, 32 of the main intake pipe 3 in communication with the swirl pipe 221 and filler pipe 211. This configuration is shown in FIG. 2.
Putting the first pipe 31 of the main intake pipe 3 in communication with the swirl pipe 221 and filler pipe 211. The electric compressor can then compress the intake air, which is divided between the swirl pipe 221 and filler pipe 211. This configuration is shown in FIG. 3.
Closing off the swirl pipe 221 and filler pipe 211 so as to shut off the engine to stop it.

According to another embodiment of the invention, the valve 4 is configured so as to put the first pipe 31 of the main intake pipe 3 in communication with one of the two pipes 211, 221 of the double manifold 2.

According to another embodiment of the invention, the valve 4 is configured so as to put one of the two pipes 211, 221 of the double manifold 2 in communication with the second pipe or bypass pipe 32 of the main intake pipe 3, thus bypassing the electric compressor 5.

Referring to FIG. 1, a first preferred embodiment of the method of use of an assembly according to the invention comprises the following steps:
non-activation of the electric compressor 5,
bypassing the electric compressor 5 by circulation of the gasses in the bypass pipe 32,
supplying the swirl pipe 221.

This method, which involves short-circuiting the electric compressor 5 and supplying the swirl pipe 221, is basically used for low loads.

Referring to FIG. 2, a second preferred embodiment of a method of using an assembly according to the invention comprises the following steps:
non-activation of the electric compressor 5,
bypassing the electric compressor 5 by circulation of the gasses in the bypass pipe 32,
supplying the swirl pipe 221 and the manifold pipe 211.

This method, which involves short-circuiting the electric compressor 5 and supplying the swirl pipe 221 and the filler pipe 211, is basically used for medium and high loads.

Referring to FIG. 3, a second preferred embodiment of a method of using an assembly according to the invention comprises the following steps:
activating the electric compressor 5,
circulating the gasses in the first intake pipe 31 via the electric compressor 5,
supplying the swirl pipe 221 and the manifold pipe 211.

This method, which involves supplying the swirl pipe 221 and the filler pipe 211 via the electric compressor 5, is basically used for high load demands in transient phases.

Referring to FIG. 4, a second preferred embodiment of a method of using an assembly according to the invention involves not supplying the swirl pipe 221 and the manifold pipe 211 by using the valve as a shut-off butterfly valve.

The valve thus allows the engine to be stopped, particularly in the context of a diesel engine where safety regulations require a shut-off butterfly valve to prevent the engine from continuing to run on something other than the injected fuel, such as oil resulting from a leak, for example.

The scope of this invention is not limited to the details given above and allows embodiments under numerous other specific forms without departing from the scope of protection of the invention. Consequently, the present embodiments must be considered to be by way of illustration and can be modified without, however, departing from the scope defined by the claims.

1. An assembly for a combustion engine comprising:
an electric compressor; and
an air intake system comprising a double manifold at the inlet to which there is a valve configured to allow the intake gases to circulate in the manifold and/or to allow the intake gases to bypass the electric compressor.

2. The assembly for a combustion engine according to claim 1, wherein the double manifold comprises a swirl manifold and a filler manifold, fed by two independent inlets, which are closed off by the valve independently of one another.

3. The assembly for a combustion engine according to claim 1, comprising a pipe bypassing the electric compressor, which is closed off by the valve when the electric compressor is activated.

4. The assembly for a combustion engine according to claim 1, wherein the engine's main air intake pipe divides into a first pipe and a bypass pipe that are independent and open out into the valve.

5. The assembly for a combustion engine according to claim 4, wherein the electric compressor is arranged on the first pipe upstream of the valve.

6. The assembly for a combustion engine according to claim 4, wherein the first pipe is arranged so that, at a given position of the valve the first pipe is the only pipe in communication with the filler and swirl pipes of the manifolds.

7. A method of using an assembly according to claim 1, comprising:
non-activation of the electric compressor;
bypassing the electric compressor by circulating the gases in the bypass pipe; and
feeding the swirl pipe.

8. A method of using an assembly according to claim 1, comprising:
non-activation of the electric compressor;
bypassing the electric compressor by circulating the gases in the bypass pipe; and
feeding the swirl pipe and manifold pipe.

9. A method of using an assembly according to claim 1, comprising:
activation of the electric compressor;
circulating the gases in the first intake pipe, via the electric compressor; and
feeding the swirl pipe and manifold pipe.

10. The method of claim 7, wherein the method is performed in order to prevent any circulation of fluid in a double manifold.
